(19) United States
(12) Patent Application Publication
(10) Pub. No.: US 2016/0062637 A1
(43) Pub. Date: Mar. 3, 2016

(54) METHOD, APPARATUS AND NON-TRANSITORY STORAGE MEDIUM FOR PROCESSING PUNCTUATION MARK

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-JUN MAO, Shenzhen (CN); CHIH-SAN CHIANG, New Taipei (TW); HAI-SEN LIANG, Shenzhen (CN); TE-JIA LIU, Shenzhen (CN); YA-LING LIU, Shenzhen (CN)

(21) Appl. No.: 14/753,298

(22) Filed: Jun. 29, 2015

(30) Foreign Application Priority Data
Sep. 3, 2014 (CN) 201410444539.6

(51) Int. Cl. G06F 3/0488; G06F 3/041

(52) U.S. Cl. CPC G06F 3/04883; G06F 3/041

(57) ABSTRACT

In a punctuation mark processing method, handwriting area is divided into more than one segment and a handwriting input is recognized which is associated with a punctuation mark. The location of the handwriting input within the handwriting area is determined An appropriate location for the associated punctuation mark is determined on a display of a device. The punctuation mark is displayed in the appropriate location.

### CROSS-REFERENCE TO RELATED APPLICATIONS

This application claims priority to Chinese Patent Application No. 201410444539.6 filed on Sep. 3, 2014, the contents of which are incorporated by reference herein.

### FIELD

The subject matter herein generally relates to input processing technology, and more specifically relates to, a method, an apparatus, and a non-transitory storage medium for processing punctuation marks.

### BACKGROUND

As an input method, handwriting has many advantages, for example, handwriting is a user-friendly and highly efficient method to input text. Generally, characters that are associated with handwriting input are displayed in a same height of a line.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing a punctuation mark processing system.

FIG. 2 is a block diagram of one embodiment of functional modules of the punctuation mark processing system in FIG. 1.

FIG. 3 is a diagrammatic view of on embodiment of a handwriting area and display area.

FIG. 4A is a diagrammatic view of one embodiment of a handwriting.

FIG. 4B is a diagrammatic view of one embodiment of a punctuation mark associated with the handwriting of FIG. 4A.

FIG. 5A is a diagrammatic view of another embodiment of a handwriting.

FIG. 5B is a diagrammatic view of one embodiment of a punctuation mark associated with the handwriting of FIG. 5A.

FIG. 6 is a flowchart of one embodiment of a punctuation mark processing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

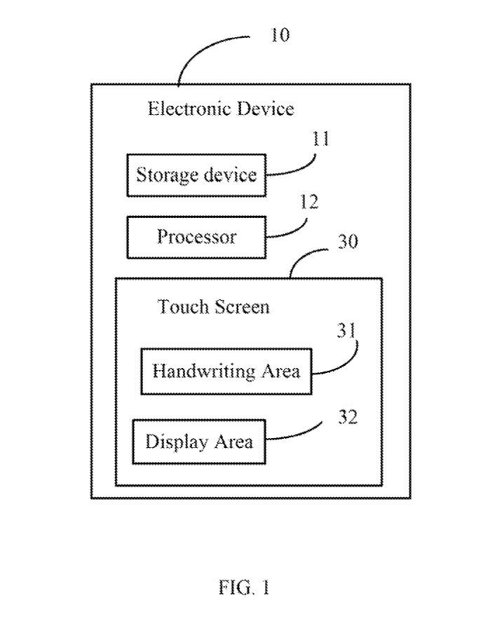

FIG. 1 is a block diagram of one embodiment of a hardware environment for executing a punctuation mark processing system. The punctuation mark processing system 20 is installed and runs in an apparatus, for example an electronic device 10. In at least one embodiment as shown in FIG. 1, the electronic device 10 includes, but is not limited to, a storage device 11, at least one processor 12, and a touch screen 30. The electronic device 10 can be a tablet computer, a notebook computer, a smart phone, a personal digital assistant (PDA), or another suitable electronic device. FIG. 1 illustrates only one example of the electronic device that can include more or fewer components than illustrated, or have a different configuration of the various components in other embodiments.

The punctuation mark processing system 20 can divide a handwriting area into more than one segment and recognize handwriting on the handwriting area which is associated with a punctuation mark. The location is determined where the handwriting lies in the handwriting area. Accordingly, the punctuation mark associated with the handwriting is displayed in an appropriate location of a line on display area.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 12 can be a central processing unit (CPU), a microprocessor, or other data processing chip that performs functions of the punctuation mark processing system 20 in the electronic device 10.

The touch screen 30 is also equipped as a display unit and includes a handwriting area 31 and a display area 32. Handwriting inputs are received in the handwriting area 31. One or more lines are displayed on the display area 32. Each of lines is used to orderly display characters associated with handwriting input. For example, the order is first from left of a first line to right of the first line, and when the first line is fully displayed, then from left of a second line to right of the second line.

In the embodiment, the handwriting area 31 and the display area 32 are two respective areas of the touch screen 30. In an alternative embodiment, the handwriting area 31 is over the display area 32, and wholly covers the entire touch screen 30 or partly covers some portion of the touch screen 30.

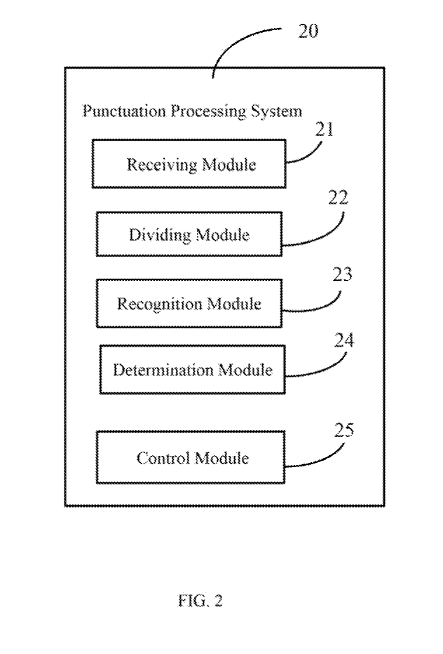

FIG. 2 is a block diagram of one embodiment of the function modules of the punctuation mark processing system 20. In at least one embodiment, the punctuation mark processing system 20 can include a receiving module 21, a dividing module 22, a recognition module 23, a determination module 24 and a control module 25. The function modules 21-25 can include computerized codes in the form of one or more programs, which are stored in the storage device 11. The at least one processor 12 executes the computerized codes to provide functions of the function modules 21-25.

The receiving module 21 can receive a request for inputting punctuation marks. In the embodiment, the receiving module 21 receives the request when a user operates a predefined touch button or selects an item from a menu.

When the receiving module 21 receives the request for inputting punctuation marks, the dividing module 22 can divide the handwriting area 31 into more than one segment.

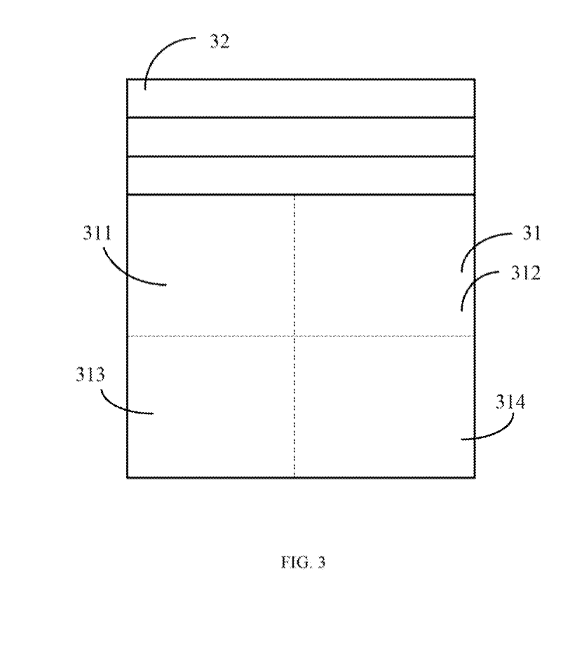

FIG. 3 illustrates in the embodiment, the dividing module 22 divides the handwriting area 31 into four segments via two perpendicular straight lines (shown as two broken lines in FIG. 3). The first segment 311 is located in an upper left corner of the handwriting area 31. The second segment 312 is located in an upper right corner of the handwriting area 31. The third segment 313 is located in a lower left corner of the handwriting area 31. And, the forth segment 314 is located in a lower right corner of the handwriting area 31.

When the dividing module 22 divides the handwriting area 31 into more than one segment, the recognition module 23 can recognize a handwriting input on the handwriting area 31 which is associated with punctuation mark. The determination module 24 can determine a location where the handwriting input is in the handwriting area 31. The control module 25 can display the punctuation mark associated with the handwriting in an appropriate location of a line on the display area 32.

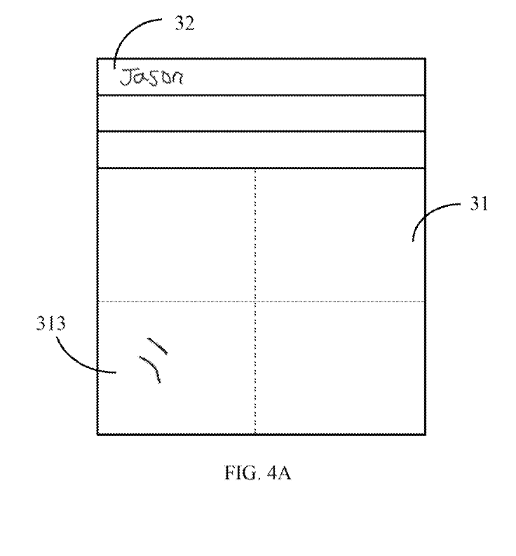

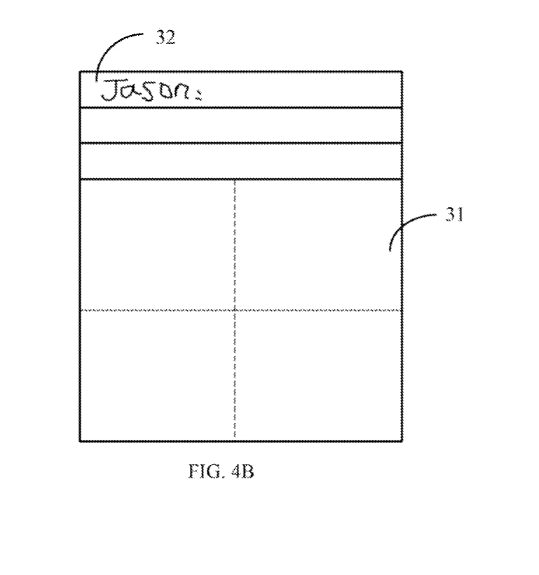

FIG. 4A illustrates when a user inputs a handwriting input “ [symbol] ” on the handwriting area 31, the recognition module 23 recognizes the handwriting input “ [symbol] ”. The determination module 24 determines the handwriting input is in the third segment 313. FIG. 4B illustrates the control module 25 displays a colon “:” associated with the handwriting input “ [symbol] ” in a subscript place of a line on display area 32.

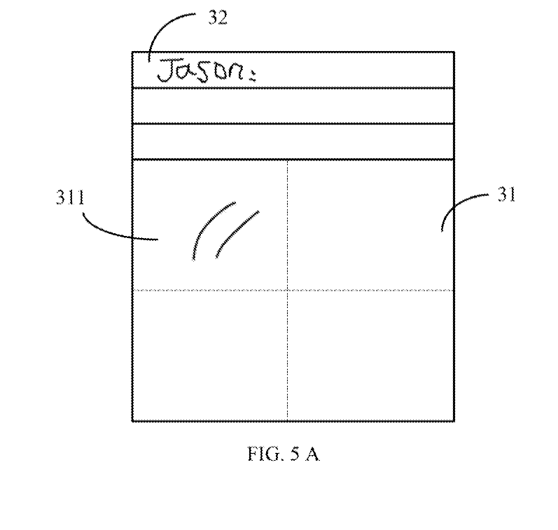

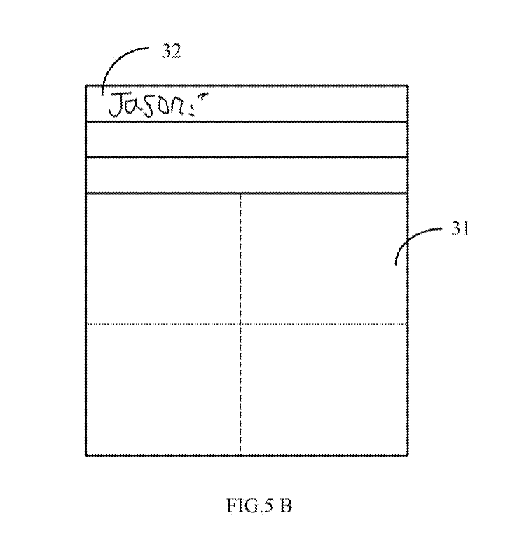

FIG. 5 A illustrates when a user inputs handwriting “ [symbol] ” on the handwriting area 31, the recognition module 23 recognizes the handwriting input “ [symbol] ”. The determination module 24 determines the handwriting input is in the first segment 311. FIG. 5B illustrates the control module 25 displays a quotation mark “”” associated with the handwriting input “ [symbol] ” in a superscript place of a line on display area 32.

In the embodiment, when the handwriting input is in the first segment 311 of the handwriting area 31, a punctuation mark associated with the handwriting input is displayed in left superscript place of a line of the display area 32, such as quotation marks “”” and “””. When the handwriting input is in the second segment 312 of the handwriting area 31, a punctuation mark associated with the handwriting input is displayed in right superscript place of a line of the display area 32, such as quotation marks “”” and “””, and displays a valence of ions or atomic groups, for example HO⁻ or O²⁻, When the handwriting input is in the third segment 313 or the fourth segment 314 of the handwriting area 31, a punctuation mark associated with the handwriting input is displayed in subscript place of a line of the display area 32, such as a period “.”, a comma “,”, a semicolon “;” and the number of atoms in a chemical formula. When the handwriting input is in any two segments, the punctuation mark associated with the handwriting input is displayed in a normal place of a line.

It is to be understood, in the embodiment, the normal place lies in a height of a line that a number of characters are mainly displayed, and is between the superscript place and subscript place of the line.

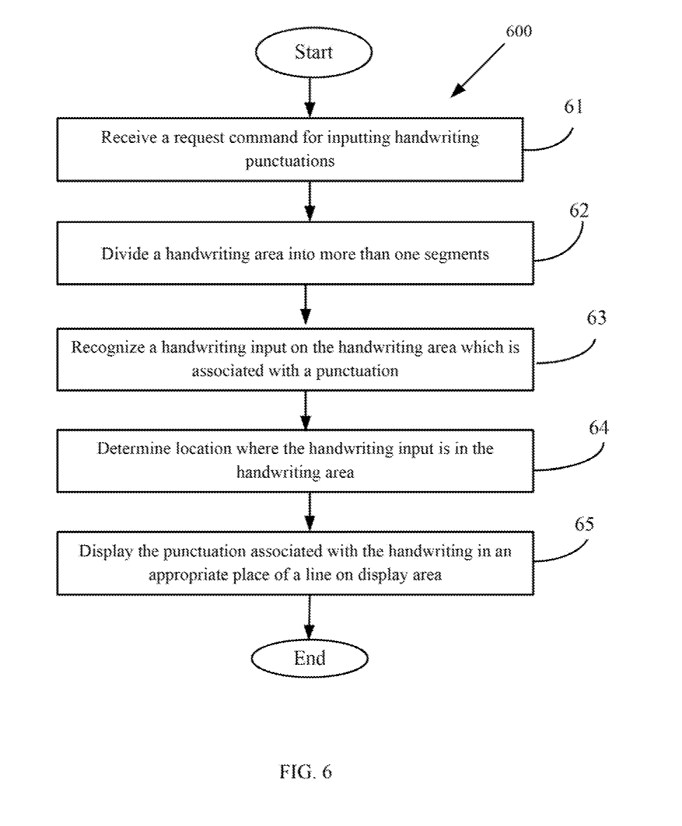

FIG. 6 is a flowchart of one embodiment of a punctuation mark processing method.

Referring to FIG. 6, a flowchart is presented in accordance with an example embodiment illustrated. The example method 600 is provided by way of example, as there are a variety of ways to carry out the method. The method 600 described below can be carried out using the configurations illustrated in FIGS. 1-2, for example, and various elements of these figures are referenced in explaining example method 600. Each block shown in FIG. 6 represents one or more processes, methods or subroutines, carried out in the exemplary method 600. Furthermore, the illustrated order of blocks is by example only and the order of the blocks can change according to the present disclosure. The exemplary method 600 can begin at block 61. Depending on the embodiment, additional steps can be added, others removed, and the ordering of the steps can be changed.

At block 61, the receiving module receives a request for inputting punctuation marks.

At block 62, the dividing module divides a handwriting area into more than one segment.

At block 63, a recognition module recognizes a handwriting input on the handwriting area which is associated with a punctuation mark.

At block 64, the determination module determines a location where the handwriting input is in the handwriting area.

At block 65, the control module displays the punctuation mark associated with the handwriting in an appropriate location of a line on display area.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for processing a punctuation mark executable by at least one processor of a computing device, the method comprising:
receiving a request for inputting handwriting punctuation marks;
dividing a handwriting area into more than one segments;
recognizing a handwriting input on the handwriting area which is associated with a punctuation mark;
determining a location of the handwriting input within the handwriting area;
determining an appropriate location for the associated punctuation mark on a display of the computing device; and
displaying the associated punctuation mark in the appropriate location.

2. The method according to claim 1, wherein the appropriate location is a superscript position of a line, a subscript position of a line or a normal position of a line.

3. The method according to claim 2, wherein the handwriting area are divided into four segments, the first segment is located in an upper left corner of the handwriting area, the second segment is located in an upper right corner of the handwriting area, the third segment is located in a lower left corner of the handwriting area, and the forth segment is located in a lower right corner of the handwriting area.

4. The method according to claim 3, further comprising displaying the punctuation mark in the left superscript of a line when the handwriting input is determined to be within the first segment.

5. The method according to claim 3, further comprising displaying the punctuation mark in the right superscript of a line when the handwriting input is determined to be within the second segment.

6. The method according to claim 3, further comprising displaying the punctuation mark in the subscript of a line when the handwriting input is determined within the third segment or in the fourth segment.

7. The method according to claim 3, further comprising displaying the punctuation mark in the normal position of a line when the handwriting input is determined within any two segments.

8. An apparatus, comprising:
a processor; and
a storage device that stores one or more programs which, when executed by the at least one processor, cause the at least one processor to:
receive a request for inputting handwriting punctuation marks;
divide a handwriting area into more than one segments;
recognize a handwriting input on the handwriting area which is associated with a punctuation mark;
determine a location of the handwriting input within the handwriting area;
determine an appropriate location for the associated punctuation mark on a display of the apparatus; and
display the associated punctuation mark in the appropriate location.

9. The apparatus according to claim 8, wherein the appropriate location of a line is a superscript position of a line, a subscript position of a line or a normal position of a line.

10. The apparatus according to claim 9, wherein the handwriting area are divided into four segments, the first segment is located in an upper left corner of the handwriting area, the second segment is located in an upper right corner of the handwriting area, the third segment is located in a lower left corner of the handwriting area, and the forth segment is located in a lower right corner of the handwriting area.

11. The apparatus according to claim 10, wherein the punctuation mark is displayed in the left superscript of a line when the handwriting input is determined within the first segment.

12. The apparatus according to claim 10, wherein the punctuation mark is displayed in the right superscript of a line when the handwriting input is determined within the second segment.

13. The apparatus according to claim 10, wherein the punctuation mark is displayed in the subscript of a line when the handwriting input is determined within the third segment or fourth segment.

14. The apparatus according to claim 10, wherein the punctuation mark is displayed in the normal position of a line when the handwriting input is determined within the any tow segment.

15. A non-transitory storage medium having stored thereon instructions that, when executed by a processor of an electronic device, causes the processor to perform a management method, wherein the method comprises:
receiving a request for inputting handwriting punctuation marks;
dividing a handwriting area into more than one segments;
recognizing a handwriting input on the handwriting area which is associated with a punctuation mark;
determining a location of the handwriting input within the handwriting area;
determining an appropriate location for the associated punctuation mark on a display of the electronic device; and
displaying the associated punctuation mark in the appropriate location.

16. The non-transitory storage medium according to claim 15, wherein the appropriate location of a line is a superscript position of a line, a subscript position of a line or a normal position of a line, the handwriting area are divided into four segments, the first segment is located in upper left corner of the handwriting area, the second segment is located in upper right corner of the handwriting area, the third segment is located in lower left corner of the handwriting area, and the forth segment is located in lower right corner of the handwriting area.

17. The non-transitory storage medium according to claim 16, wherein the punctuation mark is displayed in the left superscript of a line when the handwriting input is determined within the first segment.

18. The non-transitory storage medium according to claim 16, wherein the punctuation mark is displayed in the right superscript of a line when the handwriting input is determined within the second segment.

19. The non-transitory storage medium according to claim 16, wherein the punctuation mark is displayed in the subscript of a line when the handwriting input is determined within the third segment or fourth segment.

20. The non-transitory storage medium according to claim 16, wherein the punctuation mark is displayed in the normal position of a line when the handwriting input is determined within the any tow segment.
